(19) United States
(12) Patent Application Publication
(10) Pub. No.: US 2007/0224018 A1
(43) Pub. Date: Sep. 27, 2007

(54) Fastening device

(76) Inventors: Charles A. DePerro, Sterling Heights, MI (US); John Kosidlo, White Lake Twp., MI (US); Mike Danby, Stoney Creek (CA); John Wilusz, Hamilton (CA)

Correspondence Address: MCDONALD HOPKINS LLC, 600 Superior Avenue, East, Suite 2100, CLEVELAND, OH, 44114-2653, US

(21) Appl. No.: 11/713,989

(22) Filed: Mar. 5, 2007

Related U.S. Application Data
(60) Provisional application No. 60/779,139, filed on Mar. 3, 2006.

(51) Int. Cl. F16B 37/04

(52) U.S. Cl. 411/175

(57) ABSTRACT

The present invention provides a fastener device having a threaded screw, a retainer clip having two clamping sections, a threaded nut, and a securing member. The nut is capable of engagement with the screw to provide simultaneous clamping force to the clamping sections.

### CROSS-REFERENCE TO RELATED APPLICATIONS

This application claims priority from U.S. Provisional Patent Application No. 60/779,139, entitled “Fastening Device” filed on Mar. 3, 2006, which is hereby incorporated by reference herein.

### FIELD OF THE INVENTION

The present invention is generally related to fastening devices, and more particularly to clip fasteners having a secured screw.

### BACKGROUND OF THE INVENTION

Airbags on vehicles have become a common, if not standard, available feature. Vehicle manufacturers are including more airbags and at an ever increasing number of locations on vehicles. For example, more and more vehicles are being offered with side airbags, in addition to the more traditional passenger and driver front airbags. As airbag usage increases, the assembly concerns of airbag installation has become increasingly important.

In order to install airbags, fastening devices are required. The proper fastening device used depends upon the type of vehicle, the type of airbag installed, and the location on the vehicle to which the airbag in installed. Conventional fastening devices do not make side curtain airbags self-retaining to the vehicle without the aid of a secondary device, which is often a temporary fastener. For example, plastic Christmas tree fasteners are often used. These fasteners, however, are temporary and often require an operator to drive a separate screw through the permanent fastener to secure the joint. These separate features add to part ordering and assembly complexities. Another deficiency of conventional fasteners is that airbag manufacturers staple the airbag to the steel clip portion of the fastener.

These deficiencies increase the man-hours required to assemble the vehicle. They also increase the total part numbers required to assemble the vehicle. Providing a self-retaining fastener device would provide a cost savings through the elimination of additional parts, operations, and manpower required in attaching a temporary fastener and inserting a separate screw. Accordingly, there is a need for self-retaining fastener devices that address these and other deficiencies of conventional fastener devices.

Additional information will be set forth in the description which follows, and in part will be obvious from the description, or may be learned by practice of the invention.

### SUMMARY OF THE INVENTION

The present invention provides a fastener device having a threaded screw, a retainer clip having two clamping sections, a threaded nut, and a securing member. The retainer clip has a body with a first leg extending upwardly to provide a first clamping section and a second leg extending downwardly to provide a second clamping section. The securing member engages the screw and provides a spring force axially along the screw during clamping to prevent the screw from backing out of engagement with the nut. The nut is capable of engagement with the screw to provide simultaneous clamping force to the clamping sections.

### DESCRIPTION OF THE DRAWINGS

Operation of the invention may be better understood by reference to the following detailed description taken in connection with the following illustrations, wherein:

FIG. 1 is schematic view of an embodiment of a fastening device.

FIG. 2 is a diagrammatical perspective view of an alternative embodiment of the fastening device.

FIG. 3 is a diagrammatical perspective view of an embodiment of the fastening device.

FIGS. 4A through C is a schematic view of an embodiment of a ¼ turn feature of the fastening device from the top, side, and bottom, respectively.

FIG. 5 is a schematic view of an alternative embodiment of the fastening device.

FIG. 6A is a schematic view of portions of the fastening device.

FIG. 6B is a top view of FIG. 6A.

### DETAILED DESCRIPTION

While the present invention is described with reference to the embodiments described herein, it should be clear that the present invention should not be limited to such embodiments. Therefore, the description of the embodiments herein is illustrative of the present invention and should not limit the scope of the invention as claimed.

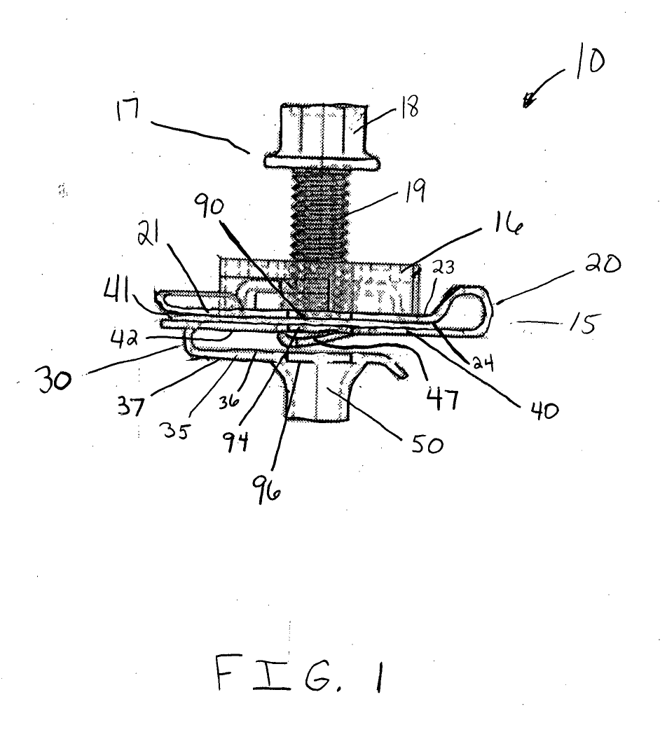

Reference will now be made to an embodiment of the invention as illustrated in accompanying FIGS. 1 through 6. The clip fastener 10 generally comprises a retainer clip 15, securing member 16, and a screw 17. Referring particularly to FIG. 1, the retainer clip 15 comprises a first u-shaped section 20 and a second u-shaped section 30 interconnected and sharing a body 40. The first unshaped section 20 has a first leg 21 and the second unshaped section has a second leg 35.

The securing member 16 may be attached to the first leg 21 and optionally a nut 50 may be attached to the second leg 35. The screw 17 may be threadingly engaged with the securing member 16 and rotatively engaged with the clip fastener 10. In one embodiment, the screw 17 is rotated and travels axially toward the nut 50. As the screw 17 threadingly engages nut 50, the clamping load of the clip fastener 10 is increased, thereby securing the clip fastener 10 and an airbag to a vehicle panel in a fixed clamp position.

The screw 17 may have a screw head 18 for wrench engagement and a threaded portion 19, as shown in FIG. 1. As shown, the head 18 may have enlarged wrenching flats. In one embodiment, the screw 17 is an M6x1.0 screw of a length capable of threading through the securing member 16 and threadingly engaging the nut 50. Threading of the screw 17 in the nut 50 increases the clamp load and securely fastens the clip fastener 10 and airbag in a fixed clamp position to a vehicle panel. It is understood that the screw 17 can be of any material, thread type, or length, as required.

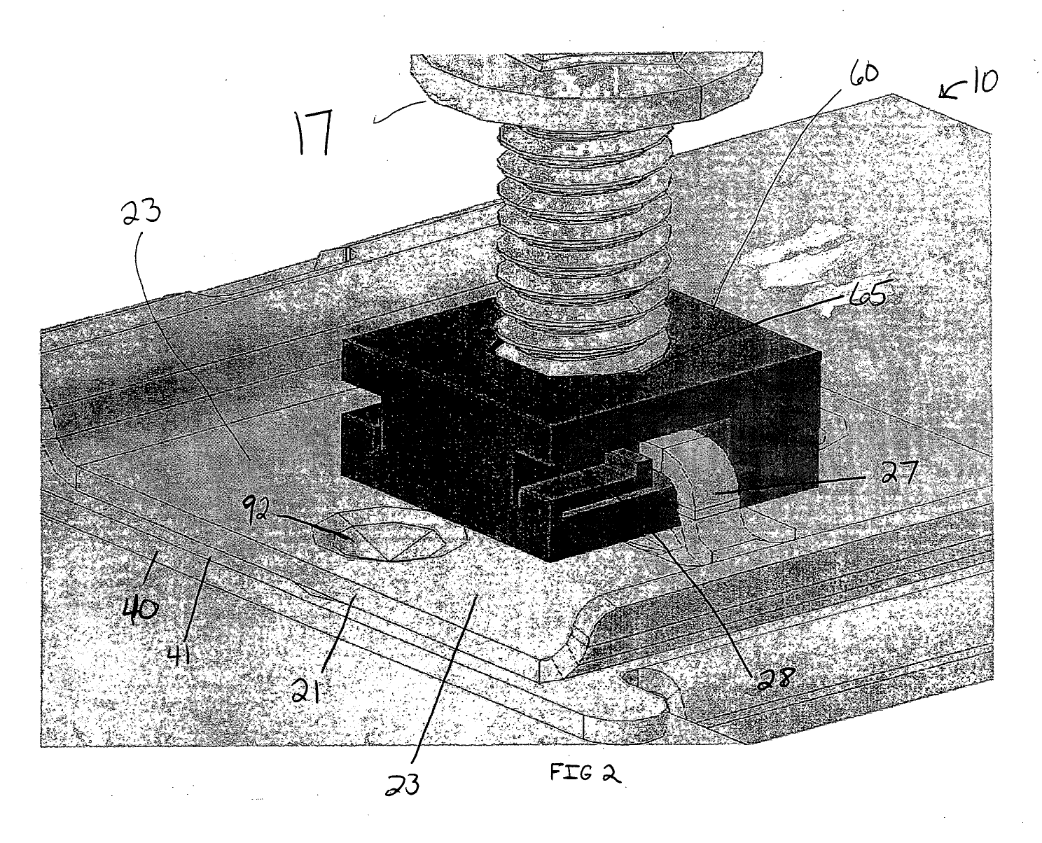

The securing member 16 attaches to the clip 15 and secures the screw 17 during shipping, air bag assembly, and installation in the vehicle. In one embodiment shown in FIG. 2, the securing member 16 is a bushing 60 with an internally threaded bore 65 for threadingly engaging the screw 17. The bushing 60 may be plastic. In one embodiment, the bushing 60 is made of nylon or other such material. However, the bushing 60 should not be deemed as limited to any specific material. One of ordinary skill in the art will appreciate the use of various materials for the bushing 60.

The retainer clip 15 may have two resiliently deformable u-shaped sections 20 and 30 comprising two resilient legs 21 and 35, respectively, interconnected by the body 40. It is understood that the u-shaped sections may be of any length and may or may not be continuous. In one embodiment, the retainer clip 15 is made from SAE 1050-1065 steel. However, the retainer clip 15 should not be deemed as limited to any specific material. One of ordinary skill in the art will appreciate the use of various materials for the retainer clip 15.

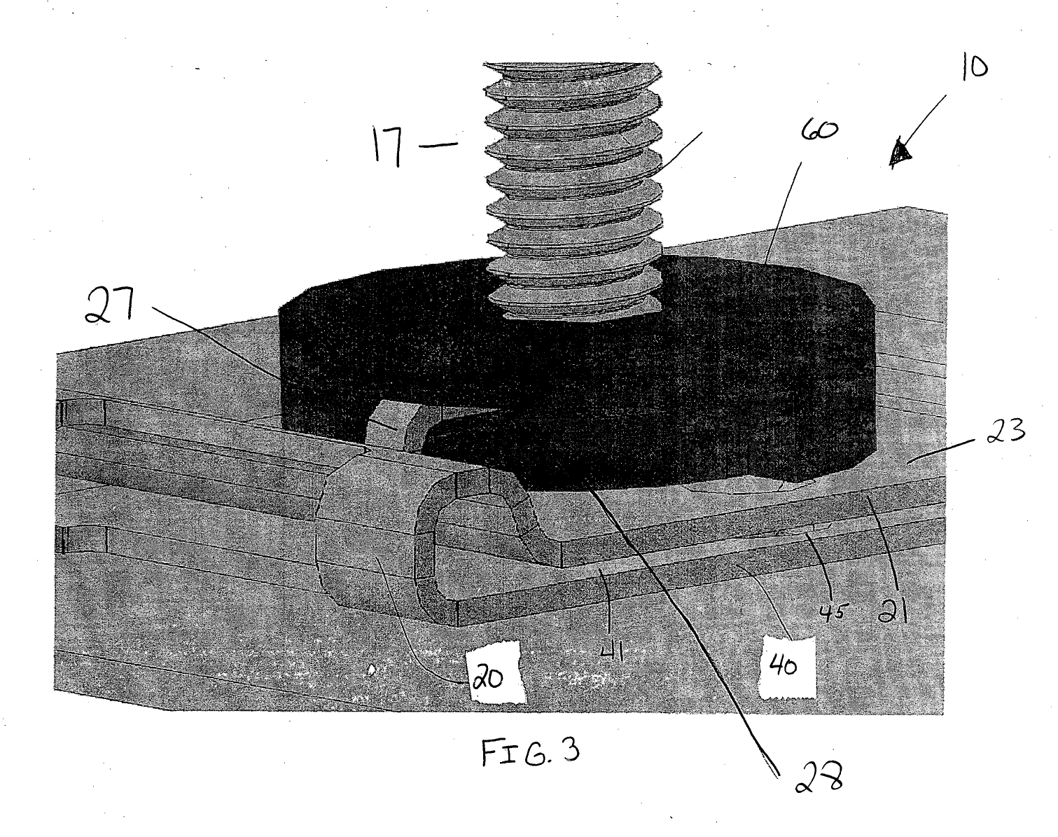

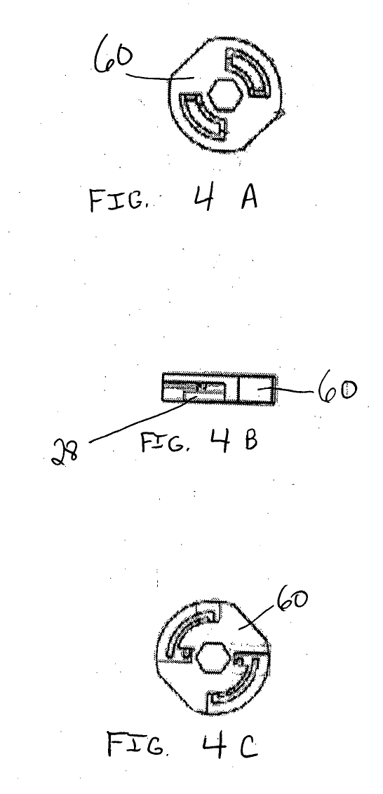

As shown in FIG. 1, the first leg 21, body 40, and second leg 35 are positioned substantially parallel with respect to each other. As shown in FIG. 1, the first leg 21 has a mounting surface 23, a clamping surface 24, and an aperture 90. The securing member 16 is positioned proximately to the mounting surface 23. The securing member 16 is attached to the mounting surface 23 in a position aligned with aperture 90. It is understood that the securing member 16 may be fixedly, or removeably attached to the mounting surface 23 by any means known in the art. As attached, securing member 16 resists spinning and allows the screw 17 to rotate when driven. In one embodiment, the first leg 21 may include one or more tabs 27 which engage corresponding openings in the securing member 16. As shown in FIGS. 3-4, the tabs 27 engage channels 28 utilizing a ¼ turn feature to capture a bushing 60.

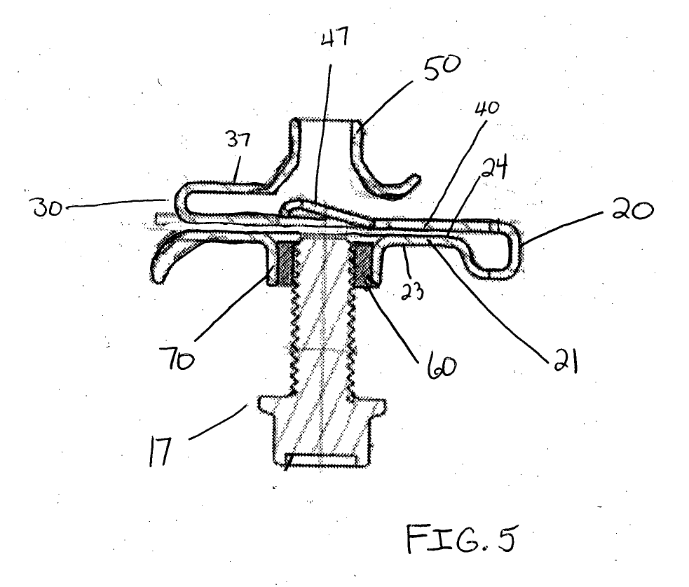

In another embodiment, the securing member 16 may be a “press in” barrel feature 70 as shown in FIG. 5. Accordingly, bushing 60 may be a bushing with a donut-like feature that is press fit into a threaded or unthreaded barrel feature 70. The securing member 16 could also be reduced to a feature integrally incorporated into the first leg 21 itself, such as threading, self-retaining fingers or other such devices, potentially eliminating the need for bushings. In yet another embodiment shown in FIG. 2, the securing member 16 may have a slide feature that utilizes channels 28 with tabs 27 to secure a bushing 60.

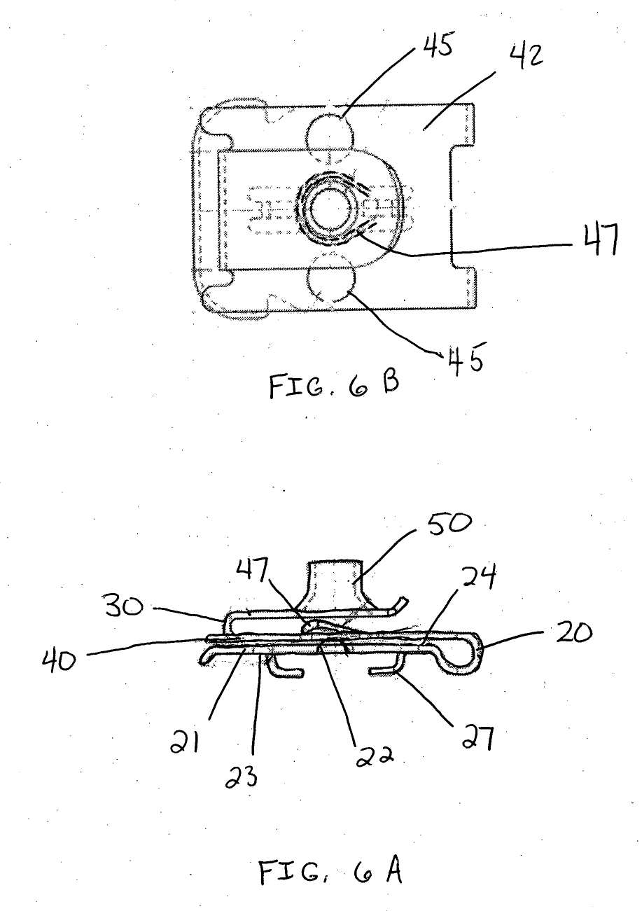

The first leg 21 may also be provided with one or more raised portions 22 mounted on or integral to the clamping surface 24. The raised portion may include bumps, barbs, or both. In one embodiment, the raised portion 22 may comprise bumps formed by pressing the mounting surface 23 of the first leg 21. As shown in FIG. 6A, the resulting raised portion 22 extends perpendicularly from the clamping surface 24 of the first leg 21 toward the body 40. FIG. 2 shows a dimple 92 on the mounting surface 23 of the first leg 21 resulting from the pressing process.

The body 40 is positioned between and interconnects the first and second u-shaped sections 20 and 30, respectively. As shown in FIG. 1, the body 40 has a first surface 41 for clamping the airbag, a second surface 42 for clamping the vehicle panel, and an aperture 94 for allowing the passage of screw 17. As shown in FIG. 6B, the body 40 may be provided with an aperture or apertures 45 corresponding to the raised portion 22 of the clamping surface 24 of the first leg 21. The apertures 45 of the body 40 help the raised portion 22 retain the airbag prior to rotating the screw 17 to reach a fixed clamp position. It is understood that a raised portion may be attached or integral to the first surface 41 of the body 40. Such a raised portion may include one or more bumps, barbs, or both. Likewise, it is understood that the first leg 21 may be provided with similar apertures to correspond to any raised portion of the body 40.

As shown in FIG. 1, a registering member 47 may be attached or integral to the second surface 42 of the body 40 for aiding in locating the clip fastener 10 into a corresponding aperture provided in a vehicle panel. As shown in FIG. 6B, the registering member 47 may be annular and positioned so as to allow the screw 17 to travel through the registering member 47 to engage the nut 50. In one embodiment, the registering member 47 may comprise barbs. In another embodiment, the registering member 47 may have a resilient tab-like shape as shown in FIGS. 1, 6A and 6B.

The second unshaped section 30 is attached to the body as shown in FIG. 1. The second u-shaped section 30 has a second leg 35 with a clamping surface 36, a mounting surface 37, and an aperture 96.

The nut 50 may be positioned proximately to the mounting surface 37 of the second leg 35. The nut 50 is positioned with respect to the aperture 96 of the second leg 35 in a manner to allow passage of the screw 17 through the retainer clip 15 to the nut 50. It is understood that the nut 50 may be attached to the mounting surface 37 of the second leg 35 by any means known by one of ordinary skill in the art. Accordingly, nut 50 resists spinning and threadingly engages the screw 17.

The nut 50 may be attached to the body as shown in FIG. 1. In one embodiment, the nut 50 is a barrel that extends outwardly from the mounting surface 37 of the second leg 35. In another embodiment, the nut 50 may be integral with the second leg 35 and can comprise an M6x1.0 u-nut thread.

Turning to the clip fastener 10, an example of how to use the clip fastener 10 as illustrated in FIGS. 1-6 is set forth below. The clip fastener 10 may be prepositioned along a vehicle panel with an aperture. The vehicle panel is inserted between second surface 42 of the body 40 and the clamping surface 36 of the second leg 35. The fastening device may then be positioned on the vehicle panel so that the registering member 47 engages the aperture of the vehicle panel. The registering member 47 engages the aperture in the vehicle panel and secures the clip fastener 10 therein. Accordingly, the clip fastener 10 is self-attaching to the vehicle panel due to the registering member 47. The registering member 47 also aligns the screw 17 and nut 50 with the aperture in the vehicle panel. Accordingly, the clip fastener 10 is held in place without the use of a secondary temporary fastening device, special tools, or rivets.

Next, the airbag may be inserted between the first surface 41 of the body and the clamping surface 24 of the first leg 21. The raised portion 22 engages and secures the airbag prior to rotating the screw 17 to achieve the fixed clamp position. Accordingly, the airbag is held in place without the use of a temporary fastening device.

As the screw 17 is engaged with the securing member 16, the securing member 16 provides adequate pressure to the screw 17 to hold the screw 17 in place. A tool assembly having a rotating wrench and non-rotating housing may engage the head 18 of the screw 17. In one embodiment, the tool is a torque gun. To this end, the tool may rotate the screw 17. The securing member 16 allows the screw 17 to rotate and travel axially so that the screw 17 can threadingly engage the nut 50. The securing member 16 may be designed to strip out when adequate torque is sustained for the screw 17 to achieve the required clamp load for a fixed clamp position. As the screw 17 is rotated, it travels axially through the aperture 90 of the first leg 21, the aperture 94 of the body 40, the registering member 47, the aperture of the vehicle panel, and the aperture 96 of the second leg 35.

As the screw engages and travels axialy through the nut 50, the first leg 21 and second leg 35 are directed toward the first and second body surfaces 41 and 42, respectively. Accordingly, this increases the clamp load on the vehicle panel and airbag. Torque is provided until the desired clamp load is reached to obtain a fixed clamp position. Accordingly, the airbag is securely clamped to the vehicle panel.

By securing the screw 17, the clip fastener 10 eliminates an end item part number in the vehicle manufacturer's facility. This results in less man-hours per vehicle and assembly cost. It also reduces the currently used u-nut and small steel clip into a single clip, reducing cost and complexity. This clip fastener 10 also eliminates the difficult stapling operation that the airbag manufacturers currently use to fasten the steel clip to the air bag.

The clip fastener 10 also eliminates the need for a secondary locator or temporary fastener such as a Christmas tree fastener for temporary installation into the vehicle. Therefore it allows for the airbag to be hung and reduces the man-hours per vehicle required.

The invention has been described above and, obviously, modifications and alternations will occur to others upon a reading and understanding of this specification. The claims as follows are intended to include all modifications and alterations insofar as they come within the scope of the claims or the equivalent thereof.

We claim:

1. A fastening device comprising:
a threaded screw having a head;
a retainer clip comprising:
a body having an aperture therethrough capable of receiving said threaded screw;
a first leg extending upwardly from said body to provide a first clamping section;
a second leg extending downwardly from said body to provide a second clamping section;
a threaded nut located downwardly of said second leg and aligned coaxially with said body aperture and capable of engagement with said threaded screw to provide simultaneous clamping force to said first and second clamping sections between said clamping head and said threaded nut during engagement of said screw; and
a securing member having a threaded aperture therethrough and located upwardly of said first leg and capable of threaded engagement with said screw; said securing member providing a spring force axially along said screw during clamping to prevent said screw from backing out of engagement with said nut.

2. The fastening device of claim 1 wherein said first leg has an aperture aligned coaxially with said body aperture capable of receiving said threaded screw, said first leg flexibly connected to said body.

3. The fastening device of claim 2 wherein said second leg has an aperture aligned coaxially with said body aperture capable of receiving said threaded screw, said second leg flexibly connected to said body.

4. The fastening device of claim 3 wherein said securing member is removably connected to said first leg.

5. The fastening device of claim 4 wherein said first leg includes at least one bump extending downwardly within said first clamping section.

6. The fastening device of claim 5 wherein said body includes at least one barb extending upwardly within said first clamping section.

7. The fastening device of claim 6 wherein a mounting structure is held within said first clamping section and prevented from withdrawal by the engagement of said downwardly extending bump and said upwardly extending barb to engagement said airbag mounting structure.

8. The fastening device of claim 7 wherein said body including a downwardly extending registering member to assist in aligning said apertures with the apertures in corresponding mounting members.

9. The fastening device of claim 8 wherein said first clamping section is connected to a vehicle frame and said second clamping section is connected to an airbag support structure.

10. The fastening device of claim 9 wherein said securing member is made of plastic.

11. The fastening device of claim 9 wherein said securing member is made of nylon.
